(19) United States
(12) Patent Application Publication
(10) Pub. No.: US 2022/0132461 A1
(43) Pub. Date: Apr. 28, 2022

(54) Positioning Method

(71) Applicant: Hitachi, Ltd., Tokyo (JP)

(72) Inventor: Hisanori MATSUMOTO, Tokyo (JP)

(21) Appl. No.: 17/451,067

(22) Filed: Oct. 15, 2021

(30) Foreign Application Priority Data
Oct. 28, 2020 (JP) 2020-180070

(51) Int. Cl. H04W 64/00; H04W 28/04; G01S 5/04; G01S 5/06

(52) U.S. Cl. CPC H04W 64/003; G01S 5/06; G01S 5/04; H04W 28/04

(57) ABSTRACT

Disclosed is a method of determining a position of a target node in accordance with radio signals transmitted and received between the target node and one or more reference nodes. According to the method, values of different positioning-related parameters are acquired, the positioning-related parameters being estimated from the radio signals. An error of a positioning value of the target node, the positioning value being calculated based on a value of each of different positioning-related parameters, is determined based on at least either the positioning value or a previously determined position of the target node. A weight of each of the different positioning-related parameters is determined, based on the error. The position of the target node is determined in accordance with a positioning value calculated based on the weight and on the value of each of the different positioning-related measurement parameters.

### CLAIM OF PRIORITY

The present application claims priority from Japanese patent application JP 2020-180070 filed on Oct. 28, 2020 the content of which is hereby incorporated by reference into this application.

### TECHNICAL FIELD

The present invention relates to a positioning method.

### BACKGROUND ART

Radio frequency bands used in mobile phone communication are expected to be expanded further to include higher frequency bands in the future. It is expected, for example, that the 5G evolution system and the 6G system, which will be put into practical use in near future, will involve advanced use of the millimeter wave band and terahertz wave band. Utilizing these high frequency bands is essential to achieving faster communications with a larger traffic capacity. Using higher frequency bands, however, poses a problem that the higher the frequency of a radio wave is, the shorter the distance the radio wave can travel.

It is assumed, therefore, that in the 5G evolution system and the 6G system, for example, numbers of small cell base stations will be used, in addition to existing macrocell base stations. Small cell base stations densely installed in indoor environments send beams with directivities of the millimeter wave band or terahertz wave band to user terminals. This achieves a highly reliable communication network.

It is considered that utilizing densely arranged base stations makes positioning of a user terminal possible. Specifically, if the installation coordinates of each base station are known in advance, an angle of a beam or a time of arrival of a radio wave, the beam or radio wave being sent from the base station to the user terminal, is checked with respect to the installation coordinates serving as reference coordinates. By this process, the position of the user terminal can be geometrically calculated. A system characterized by this process is expected to achieve highly precise positioning with a positioning error of several centimeters or less.

As a conventional wireless positioning method, a method involving two steps has been known, the two steps being a step of acquiring parameters related to positioning through communication between a measurement target, such as a user terminal, and a reference point, such as a base station, and a step of carrying out a position estimation on the basis of the parameters related to positioning. Two-step positioning methods using various types of parameters related to positioning are known. For example, JP 2012-98071A discloses an example of a technique that adopts a time difference of arrival as a positioning-related parameter.

### CITATION LIST

### Patent Literature

PLT 1: JP 2012-98071 A

### SUMMARY OF INVENTION

### Technical Problem

However, a positioning method utilizing a communication infrastructure in which small cell base stations are densely arranged is not embodied yet. Over the course of studying the positioning system utilizing such a communication infrastructure, the inventors have extracted problems to be solved, discussed specific solutions to the problems, and finally conceived the present invention. The conventional positioning method poses a problem that a place where positioning precision is high and a place where positioning precision is low coexist in a positioning area, which has to do with a pattern of arrangement of reference points and the presence or absence of an obstacle in a positioning area.

In a positioning system utilizing an environment in which small cell base stations are densely installed, such as the 5G evolution and 6G systems, base stations are not always arranged into a regular checkered pattern, and it is conceivable that a large number of base stations are three-dimensionally arranged at irregular coordinates. Besides, urban areas and indoor areas are severe multipath environments in which base stations are surrounded with many obstacles.

For this reason, when positioning of the user terminal is carried out by the conventional positioning method, extremely complicated positioning error distributions result in the positioning area. As a result, a number of points at which positioning precision drops significantly may conceivably arise.

### Solution to Problem

One aspect of the present disclosure is a method of determining a position of a target node in accordance with radio signals transmitted and received between the target node and one or more reference nodes, the method including: acquiring values of different positioning-related parameters, the values being estimated from the radio signals; determining an error of a positioning value of the target node, the positioning value being calculated based on a value of each of different positioning-related parameters, based on at least either the positioning value or a previously determined position of the target node; determining a weight of each of the different positioning-related parameters, based on the error; and determining the position of the target node in accordance with a positioning value calculated based on the weights and on the value of each of the different positioning-related parameters.

### Advantageous Effects of Invention

According to one aspect of the present invention, the precision of positioning of a target node can be improved.

### BRIEF DESCRIPTION OF DRAWINGS

FIG. 1 schematically shows a configuration of a positioning system according to an embodiment disclosed in the present specification.

FIG. 2 is a block diagram schematically showing a configuration of a terminal.

FIG. 3 is a block diagram showing a functional configuration of a base station.

FIG. 4 shows an example of a functional configuration of a positioning apparatus.

FIG. 5 shows an example of a hardware configuration of the positioning apparatus.

FIG. 6 is a sequence diagram showing transmission and reception of information of an angle of arrival (AOA) of a positioning signal in the positioning system.

FIG. 7 is a sequence diagram showing transmission and reception of information of a time of arrival (TOA) of a positioning signal in the positioning system.

FIG. 8 is a sequence diagram showing transmission and reception of information of a time difference of arrival (TDOA) of a positioning signal in the positioning system.

FIG. 9 schematically depicts a flow of information between the terminal, base stations, and the positioning apparatus, the information flow being needed for carrying out positioning of the terminal in the positioning system.

FIG. 10 is an example of a flowchart showing an outline of a method of positioning of the terminal carried out by the positioning apparatus.

FIG. 11 depicts an example of a more specific method of positioning of the terminal 30 that is carried out in accordance with the method of positioning shown in FIG. 10.

FIG. 12 is an example of another flowchart showing an outline of the method of positioning of the terminal carried out by the positioning apparatus.

FIG. 13 depicts an example of a more specific method of positioning of the terminal that is carried out in accordance with the method of positioning shown in FIG. 12.

FIG. 14 depicts an example of a more specific method of positioning of the terminal that is carried out in accordance with the method of positioning shown in FIG. 12.

### DESCRIPTION OF EMBODIMENTS

In the following, descriptions will be made separately in multiple sections or embodiments when necessary for convenience. It should be noted, however, that unless otherwise specified, the sections or embodiments are not unrelated to each other, and that one section or embodiment is a partial or the entire modification, detailed description, supplementary explanation, and the like of another section or embodiment. In the following description, when the number of elements and the like (including the numerical values, amount, and range of elements) is referred to, the number of elements is not limited to a specific number unless otherwise specified or clearly limited to the specific number by logical requirements, and may be larger or smaller than the specific number or equal thereto.

A method for carrying out positioning of a target node through wireless communication between the target node, i.e., a node whose position is to be measured, and reference nodes will hereinafter be described. The reference nodes are, for example, small cell base stations, and may be put in geometrically irregular arrangement.

Various positioning-related parameters for positioning of the target node are known, and various positioning methods based on those parameters are available, too. Depending on arrangement of the reference nodes and the presence or absence of an electromagnetic obstacle in a positioning area, each positioning method offers measurement precision that is not uniform over the entire positioning area, and has a unique error distribution. Optimum positioning methods, therefore, vary depending on positions in the positioning area.

A positioning method according to an embodiment disclosed in the present specification adaptively determines a weight (degree of contribution) of each of a plurality of different positioning methods, with respect to the position of the target node. The position of the target node is estimated, based on the weight of each of the different positioning methods and on a positioning value. By this process, fine positioning precision over the entire positioning area can be achieved.

### First Embodiment

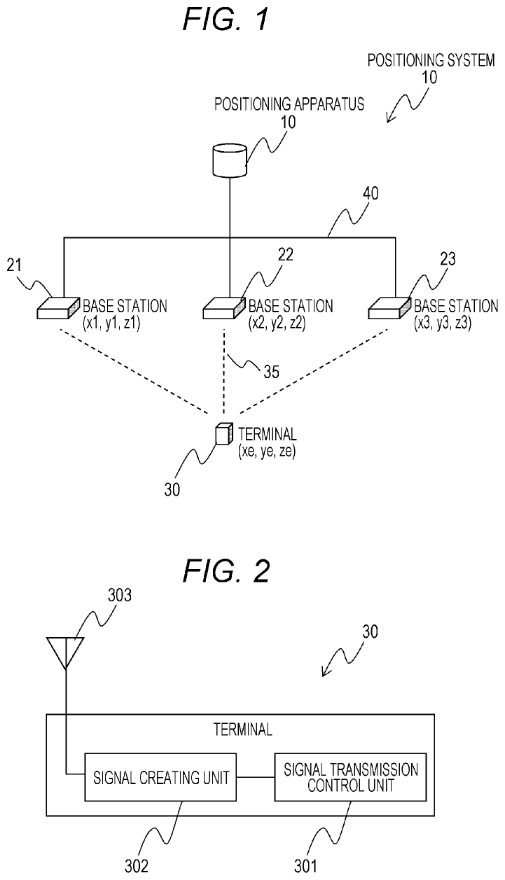

FIG. 1 schematically shows a configuration of a positioning system according to an embodiment disclosed in the present specification. A positioning system 1 includes base stations 21, 22, and 23, and a positioning apparatus 10. The positioning system 1 carries out positioning of a terminal 30 to identify its position (xe, ye, ze). In an example described below, the three-dimensional position of the terminal 30 is measured. In another example, however, the two-dimensional position of the terminal 30 may be measured.

In the present specification, the terminal 30, whose position is to be measured, may be referred to as a target node, and the base stations 21, 22, and 23 may be referred to as reference nodes. The terminal 30 is a mobile body capable of moving in a positioning area of the positioning system 1. Respective positions (x1, y1, z1), (x2, y2, z2), and (x3, y3, z3) of the base stations 21, 22, and 23 are registered in advance and are fixed positions.

The base stations 21, 22, and 23 and the positioning apparatus 10 transmit and receive information via a network 40. The network 40 may have any given configuration using a wired or wireless communication network, and may be configured to include, for example, an optical fiber backhaul network, a wireless backhaul network using millimeter waves or terahertz waves, a LAN, or a WAN.

The terminal 30 includes a function of transmitting a radio signal (positioning signal) 35 for measuring the position of the terminal 30. The base stations 21, 22, and 23 each have a function of estimating (generating) a given positioning-related parameter from the positioning signal 35 transmitted by the terminal 30. In FIG. 1, one positioning signal is denoted by reference sign 35. Positioning signals transmitted respectively to the base stations 21, 22, and 23 are the same or different from each other. It should be noted that the positioning signal described in the present specification may refer to a data communication packet exchanged between terminals and base stations in cellular communication, or may refer to a packet transmitted and received for the sole purpose of positioning of terminals.

Positioning-related parameters, which will be described in detail later, may include, for example, a received signal strength (RSS), a time of arrival (TOA), and an angle of arrival (AOA) of the positioning signal 35. These are examples of preferred positioning-related parameters. In addition, the base stations 21, 22, and 23 may each have a function of determining, as a positioning-related parameter, a difference (time difference of arrival (TDOA)) between the time of arrival at a different base station and the time of arrival at each of the base stations 21, 22, and 23.

The positioning apparatus 10 includes a database (not shown in FIG. 1) that stores information of respective coordinates of the base stations 21, 22, and 23. The database can store information on the positioning system that is different from the coordinate information. The positioning apparatus 10 is connected to each of the base stations 21, 22, and 23 via the network 40. The positioning apparatus 10 calculates the position of the terminal 30, using positioning-related parameters acquired from each of the base stations 21, 22, and 23 via the network 40 and information stored in the database.

In a configuration example described below, the positioning apparatus 10 calculates the position of the terminal 30. In another configuration example, however, a different device, e.g., a base station or a terminal, may acquire information necessary for calculating the position of the terminal 30 and calculate its position.

FIG. 2 is a block diagram schematically showing a configuration of the terminal 30. The terminal 30 includes a signal transmission control unit 301, a signal creating unit 302, and an antenna 303. The signal transmission control unit 31 decides that the terminal 30 transmit a positioning signal on the basis of a signal for positioning received from the base station, information from a sensor or a timer in the terminal 30, and the like. Receiving an instruction from the signal transmission control unit 301, the signal creating unit 302 creates a positioning signal and transmits it from the antenna 303. This positioning signal has an identifier uniquely assigned to each terminal 30, which identifier indicates from which terminal 30 the positioning signal comes from.

The terminal 30 has hardware components which may include, for example, a processor, i.e., an arithmetic processing unit, a memory, i.e., a storage device storing a program executed by the processor and data to refer to, a signal processing circuit that executes prescribed signal processing, a wireless interface, and an antenna. The terminal 30 has hardware components of any given types that provide the terminal 30 with its functions, and the functions can be implemented by one or more of the above hardware components.

FIG. 3 is a block diagram showing a functional configuration of each of the base stations 21, 22, and 23. FIG. 3 depicts only the functional block related to positioning in a microcell base station of a mobile phone system. In an example described below, the base stations 21, 22, and 23 have the same configuration. In a different configuration example, however, the base stations 21, 22, and 23 may have configurations different from each other.

The base station includes a positioning-related parameter measuring unit 201, a signal sender determining unit 202, a positioning-related parameter notification creating unit 203, a communication unit 204, a memory 205, and an antenna 206. The positioning-related parameter measuring unit 201 measures positioning-related parameters of the positioning signal 35 transmitted from the terminal 30. The base station measures a plurality of positioning-related parameters. In the example described below, the positioning-related parameters include an angle of arrival, a time of arrival, and a time difference of arrival of the positioning signal. Different packets may be used for measuring different positioning-related parameters, and measurements of different positioning-related parameters may be taken from the same packet.

The positioning-related parameter measuring unit 201 sends acquired information to the positioning-related parameter notification creating unit 203. The positioning-related parameter notification creating unit 33 creates a positioning-related parameter notification message including the positioning-related parameters of the positioning signal 35 and information for identifying the terminal 30 as a signal sender.

The communication unit 204 functions as an interface that connects the base station to the network 40. The communication unit 204 transmits a positioning-related parameter notification message created by the positioning-related parameter notification creating unit 203, to the positioning apparatus 10 via the network 40.

The base station has hardware components which may include, for example, a processor, i.e., an arithmetic processing unit, a memory, i.e., a storage device storing a program executed by the processor and data to refer to, a signal processing circuit that executes prescribed signal processing, a wireless interface, and an antenna. The base station has hardware components of any given types that provide the base station with its functions, and the functions can be implemented by one or more of the above hardware components.

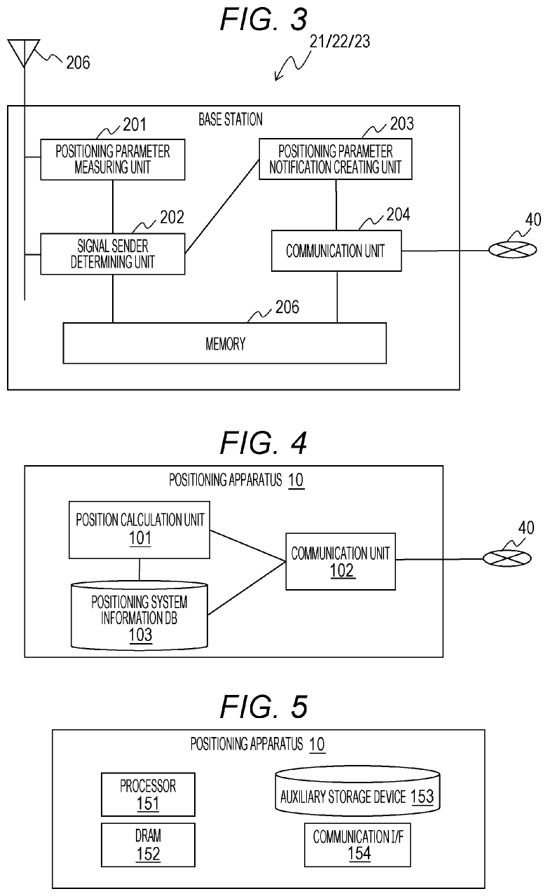

FIG. 4 shows an example of a functional configuration of the positioning apparatus 10. The positioning apparatus 10 includes a position calculation unit 101, a communication unit 102, and a positioning system information database 103. The positioning system information database 103 stores information on the positioning system 1 that is referred to for positioning, the information including coordinate information on the base station. The positioning system information database 103, as it will be described later, may store, for example, a preliminary measurement error distribution over the entire positioning area for each of different positioning methods.

The communication unit 102 functions as an interface that connects the positioning apparatus 10 to the network 40, receiving positioning-related parameter notifications sent from the base stations 21, 22, and 23 and sending the position-measurement-related parameter notifications to the position calculation unit 101. The position calculation unit 101 calculates the current position of the terminal 30, based on the positioning-related parameters included in the positioning-related parameter notifications and on position information on the base stations 21, 22, and 23, the position information being acquired from the positioning system information database 103.

As it will be described later, the position calculation unit 101 determines a weight of the position (positioning value) of the terminal 30, the position being estimated from each of different positioning-related parameters, that is, determines a degree of contribution to determination of the position of the terminal 30. The position calculation unit 101 determines the position of the terminal 30, based on the weight and the positioning value. Details of the process of determining the position of the terminal 30 by the position calculation unit 101 will be described later.

FIG. 5 shows an example of a hardware configuration of the positioning apparatus 10. The positioning apparatus 10 may have, for example, a computer-like configuration. Specifically, the positioning apparatus 10 includes a processor 151, i.e., an arithmetic processing device, and a DRAM 152 serving as a main storage device that provides a volatile temporary storage area in which programs and data executed by the processor 151 are stored.

The positioning apparatus 10 may further include an auxiliary storage device 153 that provides a permanent information storage area, using a hard disk drive (HDD), a flash memory, or the like, and an interface 156, such as a serial port for performing data communication with a different device. Furthermore, the positioning apparatus 10 may additionally include an input device, such as a mouse and a keyboard for input operations, and an output device that presents output results from processes to the user.

A program to be executed by the processor 151 and data to be processed are loaded from the auxiliary storage device 213 to the DRAM 152. Functions of the positioning apparatus 10 may be distributed to a plurality of computers. In this manner, the positioning apparatus 10 includes one or more storage devices and one or more processors.

At least some of the functions of the positioning apparatus 10 can be implemented by the processor 151 executing a program recorded in the auxiliary storage device 153. The positioning system information database 103 can be provided by the processor 151 executing a program of causing the auxiliary storage device 213 to accumulate data.

The positioning apparatus 10 may be a physical computer system (one or more physical computers) as described above, or may be constructed on a calculation resource group (a plurality of calculation resources), such as a cloud infrastructure. The computer system or the calculation resource group includes one or more interface devices (which include, for example, a communication interface device and an input/output device), one or more storage devices (which include, for example, a memory (main storage) and an auxiliary storage device), and one or more processors.

In a case where a function is implemented by execution of a program by the processor, a prescribed process is carried out, properly using the storage device and/or the interface device. In such a case, the function may be considered to be at least a part of the processor. A process explained in terms of function may be considered to be a process carried out by the processor or by a system including the processor. A program may be acquired from a program source and installed. The program source may be, for example, a program distribution computer or a computer-readable storage medium (e.g., a computer-readable non-transitory storage medium). Each function has been described as an exemplary case. In other cases, a plurality of functions may be integrated into one function or one function may be divided into a plurality of functions.

The positioning apparatus 10 of the present embodiment estimates the current position (positioning value) of the terminal 30 from different positioning-related parameters. The positioning apparatus 10 determines a weight of a positioning value (positioning-related parameter), based on at least either the positioning value or the previously determined position of the terminal 30. The positioning apparatus 10 determines the current position of the terminal 30, based on a weight of different positioning-related parameters and on the positioning values. Before description of a method of determining the position of the terminal 30 by the positioning apparatus 10, a method of collecting positioning-related parameters by the positioning apparatus 10 will be described.

In an example described below, the positioning apparatus 10 determines an estimated position of the terminal 30 by using, as positioning-related parameters, an angle of arrival, a time of arrival, and a time difference of arrival of a positioning signal from the terminal 30. It should be noted that positioning-related parameters used by the positioning apparatus 10 for position estimation are not limited to these parameters, and that some of these parameters may be omitted or other positioning-related parameters may be used. For example, the signal strength of the positioning signal is one of positioning-related parameters available.

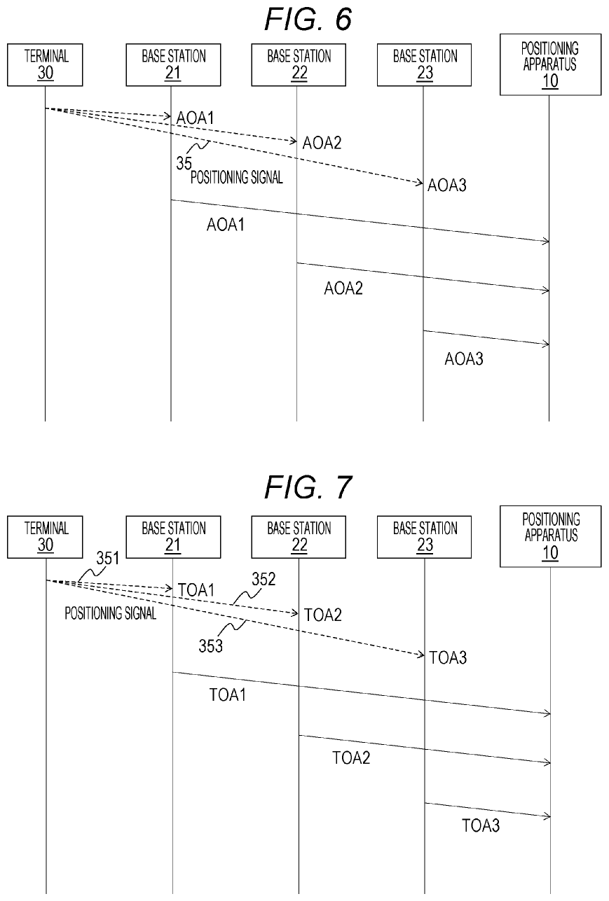

FIG. 6 is a sequence diagram showing transmission and reception of information of an angle of arrival (AOA) of a positioning signal in the positioning system 1. The terminal 30 transmits the positioning signal 35 to each of the base stations 21, 22, and 23. In FIG. 6, one positioning signal is denoted by reference sign 35, as an example.

To acquire the AOA, the base station or the terminal needs to have a function of scanning a directional beam. The most widely adopted configuration is the configuration in which the base station has a beam scanning function, and the terminal emits an omnidirectional (isotropic) electric field. In this case, the base station first casts a calling signal at the terminal while scanning a directional beam, and the terminal returns a response signal upon receiving the calling signal.

This allows the base station to know to which angle of casting of the calling signal the terminal has responded, and, consequently, to know the AOA of the positioning signal. In FIG. 6, radio signals sent from the terminal 30 to the base stations 21, 22, and 23, respectively, are indicated by broken line arrows. This schematically illustrates the above-described procedure.

Each of the base stations 21, 22, and 23 determines an angle of arrival of the positioning signal 35, from the positioning signal 35 the base station receives. For example, the antenna 206 has an array configuration, and the positioning-related parameter measuring unit 201 can measure (estimate) the angle of arrival of the positioning signal 35, based on a phase difference of the received positioning signal 35. The base stations 21, 22, and 23 transmit information of an angle of arrival AOA1, of an angle of arrival AOA2, and of angle of arrival AOA3 respectively to the positioning apparatus 10 via the network 40.

Any given type of other known methods of determining the angle of arrival can be used. The positioning apparatus 10 may acquire information necessary for calculating the angles of arrival AOA1, AOA2, and AOA3, from the base stations 21, 22, and 23, respectively, and determine the angles of arrival AOA1, AOA2, and AOA3.

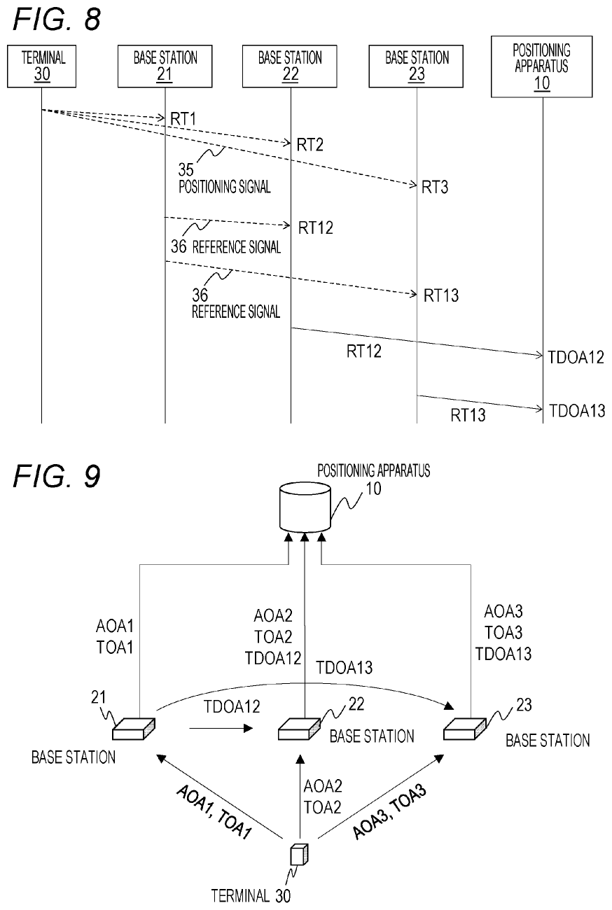

FIG. 7 is a sequence diagram showing transmission and reception of information of a time of arrival (TOA) of a positioning signal in the positioning system 1. Each of the base stations 21, 22, and 23 transmits a (calling) signal for positioning, to the terminal 30 (not shown in FIG. 7). In response to the incoming signals for positioning, the terminal 30 transmits positioning signals 351, 352, and 353 respectively to the base stations 21, 22, and 23.

The base stations 21, 22, and 23 determine a time of arrival TOA1, a time of arrival TOA2, and a time of arrival TOA3 of the incoming positioning signals 351, 352, and 353, from the positioning signals 351, 352, and 353, respectively. The time of arrival is the time the signal takes to travel from the terminal 30 to the base station.

The positioning-related parameter measuring unit 201, for example, measures a time (round trip time or RTT) that has passed from transmission of a signal for positioning to the terminal 30 to reception of a response signal (positioning signal) from the terminal 30. The time of arrival can be calculated (estimated) by subtracting a time lag caused by reception/transmission at the terminal from the RTT and dividing the RTT with the time lag subtracted therefrom by 2. Another calculation method requires a condition that a built-in timer of the terminal and that of the base station are synchronized exactly. Under this condition, the terminal writes down a transmission time in the positioning signal, and the base station checks a time of reception of the positioning signal against the transmission time written in the received positioning signal to determine the TOA. The base stations 21, 22, and 23 transmit information of the time of arrival TOA1, of the time of arrival TOA2, and of the time of arrival TOA3 respectively to the positioning apparatus 10 via the network 40.

Any given type of other known methods of determining the time of arrival can be used. The positioning apparatus 10 may acquire information necessary for calculating the times of arrival TOA1, TOA2, and TOA3, from the base stations 21, 22, and 23, respectively, and determine the times of arrival TOA1, TOA2, and TOA3.

FIG. 8 is a sequence diagram showing transmission and reception of information of a time difference of arrival (TDOA) of a positioning signal in the positioning system 1. The time difference of arrival is the difference between a time of arrival (TOA) at one base station and a time of arrival (TOA) at another base station.

The terminal 30 transmits the positioning signal 35 to each of the base stations 21, 22, and 23. In FIG. 8, one positioning signal is denoted by reference sign 35, as an example. The base stations 21, 22, and 23 measure times RT1, RT2, and RT3, respectively, at which the base stations 21, 22, and 23 each receive the positioning signal 35. The positioning-related parameter measuring unit 201 can measure a time of reception of the positioning signal 35 by referring to the built-in timer.

In response to reception of the positioning signal 35, the base station 21 then wirelessly transmits a reference signal 36 to each of other base stations 22 and 23. A delay time to take from reception of the positioning signal 35 to transmission of the reference signal 36 is constant, and is stored in advance in the positioning system information database 103 of the positioning apparatus 10.

The base station 22 measures a time of reception (reception time RS2) of the reference signal 36 from the base station 21, and calculates a difference RT12 between the reception time RS2 and the reception time RT2 representing the time of reception of the positioning signal 35 by the base station 22. The base station 22 transmits the time difference RT12 to the positioning apparatus 10 via the network 40. The base station 23 measures a time of reception (reception time RS3) of the reference signal 36 from the base station 21, and calculates a difference RT13 between the reception time RS3 and the reception time RT3 representing the time of reception of the positioning signal 35 by the base station 23. The base station 23 transmits the time difference RT13 to the positioning apparatus 10 via the network 40.

Based on the time difference RT12 and the delay time at the base station 21, the positioning apparatus 10 calculates (estimates) a time difference of arrival TDOA12 between the base station 21 and the base station 22. Similarly, based on the time difference RT13 and the delay time at the base station 21, the positioning apparatus 10 calculates (estimates) a time difference of arrival TDOA13 between the base station 21 and the base station 23.

Any given type of other known methods of determining the time difference of arrival can be used. For example, the positioning apparatus 10 may acquire the reception times RT2 and RS2 and the reception times RT3 and RS3 from the base station 22 and the base station 23, respectively, and determine the time difference of arrival TDOA12 and the time difference of arrival TDOA 13, based on the reception times RT2 and RS2 and the reception times RT3 and RS3.

FIG. 9 schematically depicts a flow of information between the terminal 30, the base stations 21, 22, and 23, and the positioning apparatus 10, the information flow being needed for carrying out positioning of the terminal 30 in the positioning system 1. In FIG. 9, pieces of information acquired respectively by constituent elements correspond to pieces of information described with reference to the sequence diagrams of FIGS. 6, 7, and 8.

Through communication with the terminal 30, the base station 21 acquires information of the angle of arrival AOA1 and of the time of arrival TOA1. In the same manner, the base station 22 acquires information of the angle of arrival AOA2 and of the time of arrival TOA2 through communication with the terminal 30, and the base station 23 acquires information of the angle of arrival AOA3 and of the time of arrival TOA3 through communication with the terminal 30.

Through communication with the terminal 30 and with the base station 21, the base station 22 acquires information of the time difference of arrival TDOA12 between the base station 21 and the base station 22. In the same manner, through communication with the terminal 30 and with the base station 21, the base station 23 acquires information of the time difference of arrival TDOA12 between the base station 21 and the base station 23. The above information acquired by the base stations 22 and 23 actually indicate differences in time of reception of the positioning signal. Nevertheless, since the time difference of arrival is determined from these differences, the information exchanged through mutual communication is considered to be substantially the same as the time difference of arrival.

From the base station 21, the positioning apparatus 10 acquires information of the angle of arrival AOA1 and of the time of arrival TOA1. From the base station 22, the positioning apparatus 10 acquires information of the angle of arrival AOA2 and of the time of arrival TOA2 and information of the time difference of arrival TDOA12 between the base station 21 and the base station 22 as well. From the base station 23, the positioning apparatus 10 acquires information of the angle of arrival AOA3 and of the time of arrival TOA3 and information of the time difference of arrival TDOA13 between the base station 21 and the base station 23 as well.

A method of determining the position of terminal 30 by the positioning apparatus 10 will hereinafter be described. In a configuration example described below, the positioning apparatus determines the position of terminal 30. In another configuration example, a different device, such as the terminal or the base station, which includes an interface, an arithmetic processing device, and a storage device may determine the position of the terminal 30 by similar processing.

A method according to one embodiment disclosed in the present specification is to determine a weight of positioning results on different positioning-related parameters (different positioning methods) and determine the position of the terminal 30, based on the positioning results and on the weight. Depending on arrangement of the base stations and the presence or absence of an electromagnetic obstacle in the positioning area, the measurement precision of each positioning method is not uniform over the entire positioning area, and has a unique distribution.

When only a single positioning method is used constantly, an area involving a large positioning error arises, depending on arrangement of the base stations and the position of the obstacle. As described in this specification, better positioning precision can be achieved over the entire positioning area, by adaptively varying a weight (degrees of contribution) of a plurality of positioning methods in accordance with a condition of the terminal, the positioning methods creating different positioning error distributions in the positioning area.

The weight of each positioning method is determined, based on an error of a positioning value made by the positioning method. In a configuration example described below, as information indicating the error of the positioning value, the likelihood of a measured position, a difference between a value derived by an autoregressive analysis of past positioning results and the positioning value, and a pre-registered preliminary measurement error distribution are referred to.

In the following example, an angle of arrival (AOA), a time of arrival (TOA), and a time difference of arrival (TDOA) are used as positioning-related parameters A positioning-related parameter different from these parameters, such as reception strength (RSS), may be used, and at least some of the above positioning-related parameters may be omitted.

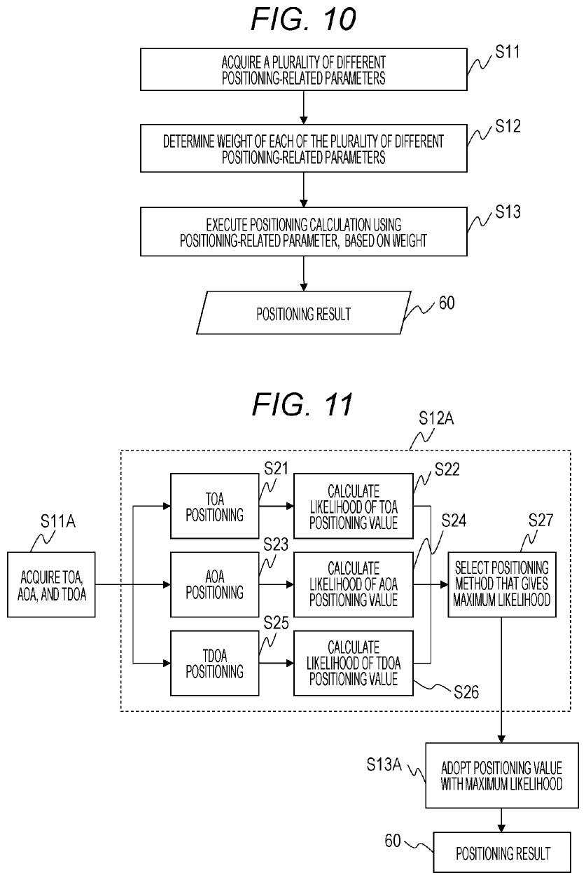

FIG. 10 is an example of a flowchart showing an outline of a method of positioning of the terminal 30 carried out by the positioning apparatus 10. As described above, the position calculation unit 101 acquires a plurality of different positioning-related parameters from a plurality of base stations (S11). The positioning-related parameters transmitted from the base stations pass through the communication interface 154 and are received by the communication unit 102, and then are stored in the storage device, e.g., the DRAM 152 or the auxiliary storage device 153. The position calculation unit 101 acquires the positioning-related parameters from the storage device. The positioning-related parameters acquired in this example are the angle of arrival (AOA), the time of arrival (TOA), and the time difference of arrival (TDOA), as mentioned above.

The position calculation unit 101 then determines a weight of each of the positioning-related parameters (S12). The weight of a positioning-related parameter is equivalent to the weight of a positioning value of the terminal 30 that is calculated from the positioning-related parameter. The weight is determined, based on the positioning value of the terminal 30 obtained from the value of the positioning-related parameter. A method of calculating the weight will be described in detail later.

Subsequently, based on the weight of each of the positioning-related parameters, the position calculation unit 101 executes a positioning calculation, using the value of the positioning-related parameter (S13). This calculation gives a positioning result 60 indicating the current position of the terminal 30. A method of the positioning calculation using the weight and the positioning-related parameter will be described in detail later.

As described above, by carrying out the positioning calculation on the terminal 30, based on the weight of the positioning-related parameter, and determining the position of the terminal 30, more proper positioning can be carried out in accordance with an environment in which the terminal 30 is placed.

FIG. 11 depicts an example of a more specific method of positioning of the terminal 30 that is carried out in accordance with the method of positioning shown in FIG. 10. The position calculation unit 101 acquires the value of the angle of arrival (AOA), of the time of arrival (TOA), and of the time difference of arrival (TDOA), as the values of position-measurement-related parameters (S11A).

The position calculation unit 101 then determines a weight of the angle of arrival (AOA), the time of arrival (TOA), and the time difference of arrival (TDOA) (S12A). To determine the weight, the position calculation unit 101 calculates the positioning value (current estimated position coordinates) of the terminal 30, from the acquired value of each of the positioning-related parameters. Various methods of positioning calculation using each positioning-related parameter are known. For example, the position calculation unit 101 can calculate (estimate) the positioning value (position or coordinates) of the terminal 30 from a positioning-related parameter value, by a geometric method or a statistical method.

The geometric method is applied in the following manner. For example, in a two-dimensional space, an intersection of three circles, the intersection being calculated from the positions of three base stations and times of arrival and reception strengths at the base stations, can be determined as the positioning value of the terminal 30. An intersection of straight lines, the intersection being calculated from the positions of two base stations and angles of arrival at the base stations, can also be determined as the positioning value of the terminal 30. Further, an intersection of two hyperbolas, the intersection being obtained from two time differences of arrival, can be determined as positioning coordinates of the terminal 30.

The statistical method determines the positioning value, based on a likelihood calculated from positioning-related parameter values. The likelihood represents the likelihood of the positioning value, and a point at which the value of the likelihood is at the maximum is determined to be the positioning value (position coordinates) of the terminal 30. The likelihood is defined by a predetermined function. For example, a likelihood P (x, y, z) in a case of carrying out TDOA positioning is expressed by the following formula.

$$P ( x , y , z ) = {\sum }_{n = 2}^{3} \frac{1}{\begin{matrix}\vert \sqrt{{( x 1 - x )}^{2} + {( y 1 - y )}^{2} + {( z 1 - z )}^{2}} - \\ \sqrt{{( x n - x )}^{2} + {( yn - y )}^{2} + {( z n - z )}^{2}} - vcTD 0 A 1 n \vert\end{matrix}} \qquad [ Mathematical formula 1 ]$$

In the formula, vc denotes the speed of light. Coordinates (xe, ye, ze) of the terminal 30 are given as coordinates (x, y, z) at which P (x, y, z) takes the maximum value. As indicated by the above formula, the likelihood P is defined by an error between a measured value for TDOA and a theoretical value for TDOA. In the same manner, a likelihood function can be defined for other positioning-related parameters, and the point at which the likelihood is at the maximum is determined to be the positioning value (position coordinate) of the terminal 30. It should be noted that the number of base stations that acquire positioning-related parameters is not limited.

As shown in FIG. 11, the position calculation unit 101 calculates a TOA positioning value from times of arrival (TOA) sent from a plurality of base stations (S21), and then calculates the likelihood of the TOA positioning value (S22). In this case, the position calculation unit 101 determines the TOA positioning value by a statistical method. For example, the position calculation unit 101 calculates the likelihood from times of arrival TOA1, TOA2, and TOA3 at three base stations 21, 22, and 23 and position coordinates thereof, and determines a position at which the value of the likelihood is at the maximum to be the positioning value of the terminal 30. The maximum likelihood value represents the likelihood value of the position given by TOA positioning.

In the same manner, the position calculation unit 101 calculates an AOA positioning value from angles of arrival (AOA) sent from a plurality of base stations (S23), and then calculates the likelihood of the AOA positioning value (S24). The position calculation unit 101 determines the AOA positioning value by a statistical method. For example, the position calculation unit 101 calculates the likelihood from angles of arrival AOA1, AOA2, and AOA3 at three base stations 21, 22, and 23 and position coordinates thereof, and determines a position at which the value of the likelihood is at the maximum to be the positioning value of the terminal 30. The maximum likelihood value represents the likelihood value of the position given by AOA positioning.

In the same manner, the position calculation unit 101 calculates an SDOA positioning value from time differences of arrival (TDOA) sent from a plurality of base stations (S25), and then calculates the likelihood of the TDOA positioning value (S26). The position calculation unit 101 determines the TDOA positioning value by a statistical method. For example, the position calculation unit 101 calculates the likelihood from time differences of arrival TDOA12 and, TDOA13 at two base stations 22 and 23 and position coordinates of three base stations 21, 22, and 23, and determines a position at which the value of the likelihood is at the maximum to be the positioning value of the terminal 30. The maximum likelihood value represents the likelihood value of the position given by TDOA positioning.

The position calculation unit 101 then determines a weight of positioning-related parameters, based on a TOA likelihood value, an AOA likelihood value, and a TDOA likelihood value. In this example, the position calculation unit 101 selects a positioning-related parameter (positioning method) that gives the maximum likelihood value (S27). In other words, the position calculation unit 101 gives a weight of 0 to a positioning-related parameter that does not give the maximum likelihood value.

Based on the weight, the position calculation unit 101 then executes a positioning calculation using the positioning-related parameters. In this example, the position calculation unit 101 adopts the positioning value determined by the positioning method that gives the maximum likelihood value (S13A). The positioning method that gives the maximum likelihood value is the positioning method that is assumed to make the least errors. By selecting the positioning method that gives the maximum likelihood value, the current position of the terminal 30 can be accurately determined with a few calculations.

As described above, selecting one positioning method (positioning-related parameter) means that in determining the position of the terminal 30, a ratio (weight) of a positioning value determined by the one positioning method is defined as 1, while ratios (weight) of positioning values determined by other positioning methods are defined as 0. In an example different from the above example, a ratio larger than 0, the ratio corresponding to a likelihood value, is given to each of different positioning methods. In this case, positioning values given by different positioning methods are mixed according to the likelihoods of the positioning values, which allows accurately determining the current position of the terminal 30.

### Second Embodiment

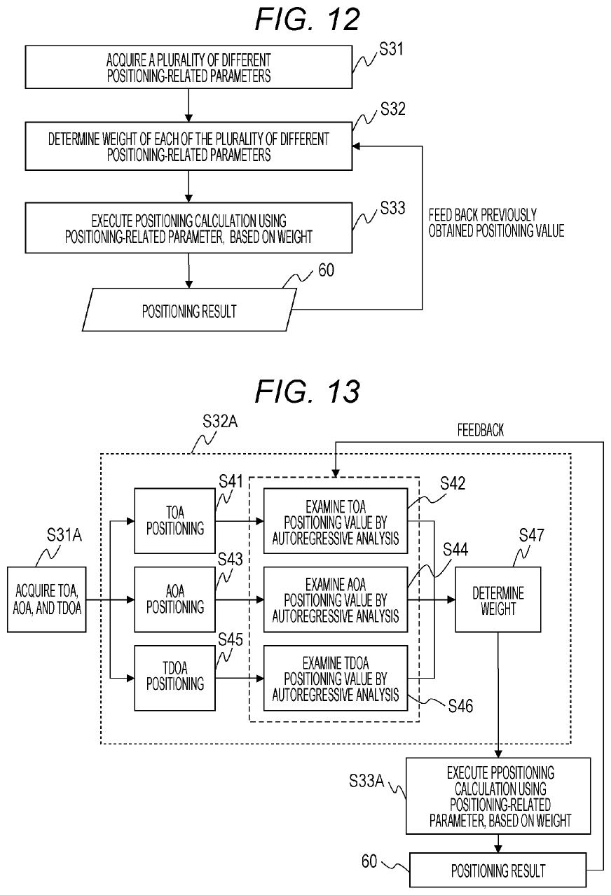

Another example of the method of positioning of the terminal 30 will be described. FIG. 12 is an example of another flowchart showing an outline of the method of positioning of the terminal 30 carried out by the positioning apparatus 10. The position calculation unit 101 acquires a plurality of different positioning-related parameters from a plurality of base stations (S31). The positioning-related parameters transmitted from the base stations are stored in, for example, the DRAM 152 or the auxiliary storage device 153. The position calculation unit 101 acquires the positioning-related parameters from the storage device. The positioning-related parameters acquired in this example are the angle of arrival (AOA), the time of arrival (TOA), and the time difference of arrival (TDOA), as mentioned above.

The position calculation unit 101 then determines a weight of each of the positioning-related parameters (S32). The weight of a positioning-related parameter is equivalent to the weight of a positioning value of the terminal 30 that is calculated from the positioning-related parameter. The weight is determined, based on the positioning value of the terminal 30 obtained from the value of the positioning-related parameter and on past positioning results. The weight can be determined properly by feeding the past positioning results back to the process of weight determination. A method of calculating the weight will be described in detail later.

Subsequently, based on the weight of each of the positioning-related parameters, the position calculation unit 101 executes a positioning calculation, using positioning-related parameter values (S33). This calculation gives a positioning result 60 indicating the current position of the terminal 30. A method of the positioning calculation using the weight and the positioning-related parameter will be described in detail later.

FIG. 13 depicts an example of a more specific method of positioning of the terminal 30 that is carried out in accordance with the method of positioning shown in FIG. 12. The position calculation unit 101 acquires the values of the angle of arrival (AOA), of the time of arrival (TOA), and of the time difference of arrival (TDOA), as the values of positioning-related parameters (S31A).

The position calculation unit 101 then determines a weight of the angle of arrival (AOA), the time of arrival (TOA), and the time difference of arrival (TDOA) (S32A). To determine the weight, the position calculation unit 101 calculates the positioning value (current estimated position coordinates) of the terminal 30, from the acquired value of each of the positioning-related parameters. Calculation of the positioning value is the same calculation as described with reference to FIG. 11, and a geometric method or a statistical method can be adopted for the calculation.

The position calculation unit 101 calculates a TOA positioning value (S41), and examines the TOA positioning value by an autoregressive analysis (S42). The position calculation unit 101 calculates also an AOA positioning value (S43), and examines the AOA positioning value by an autoregressive analysis (S43). The position calculation unit 101 calculates also a TDOA positioning value (S45), and examines the TDOA positioning value by an autoregressive analysis (S46).

Subsequently, the position calculation unit 101 determines a weight of three positioning methods, based on the results of examination of the three positioning values (S47). In this example, the weight indicates a mixing ratio of each of the positioning values given by the three positioning methods in determining the current position of the terminal 30. In an example described below, the mixing ratio of each positioning method is larger than 0. It should be noted that mixing ratios of positioning methods other than one positioning method being means that the one positioning method is selected for determining the position of terminal 30.

The autoregressive examination is carried out in the following manner. In a coordinate space, for example, a prescribed function is fitted to a given number of previously obtained positioning results, e.g., positioning results previously obtained at three points, and the distance between a line, i.e., the function fitted and a positioning value is determined, the distance representing an error. The difference between the line fitted and the positioning value is the difference between a theoretical value based on a previously determined position and the positioning value, and represents a statistical error. A larger mixing ratio is allocated to a positioning value that makes the above distance smaller.

In this manner, by using a previously obtained positioning value as feedback data in an autoregressive examination, a ratio between different positioning methods can be determined properly. Fitting of the prescribed function may be carried out, for example, as linear extrapolation, or as other forms of extrapolation involving polynomial fitting or other types of fitting using more complicated basis functions. A function fitting method using a value obtained by a Kalman filter as a reference point may also be adopted.

An example of determining a mixing ratio (weight) (S47) will then be described. The distances between a line fitted and the TOA positioning value, between the line fitted and the AOA positioning value, and between the line fitted and the TDOA positioning value are denoted as d_{TOA}, d_{AOA}, and d_{TDOA}, respectively. A ratio r_{TOA}:r_{AOA}:r_{TDOA} can be calculated by, for example, the following formula.

r_{TOA}:r_{TOA}:r_{TOA}=1/d_{TOA}:1/d_{AOA}:1/d_{TDOA}

A method of calculating a positioning value by mixing three positioning values, based on a mixing ratio, is as follows, where the positioning value is calculated using formulas shown below. Now the positioning value given by mixing three positioning values, the TOA positioning value, the AOA positioning value, the TDOA positioning value, and the mixing ratio are denoted respectively as (x, y, z), (x_{TOA}, y_{TOA}, z_{TOA}) (x_{AOA}, y_{AOA}, z_{AOA}), (x_{TDOA}, y_{TDOA}, z_{TDOA}), and (r_{TOA}:r_{AOA}:r_{TDOA}).

x=x_{TOA}*r_{TOA}/(r_{TOA}+r_{AOA}+r_{TDOA})+x_{AOA}*r_{AOA}/(r_{TOA}+r_{AOA}+r_{TDOA})+x_{TDOA}*r_{TDOA}/(r_{TOA}+r_{AOA}+r_{TDOA})

y=y_{TOA}*r_{TOA}/(r_{TOA}+r_{AOA}+r_{TDOA})+y_{AOA}*r_{AOA}/(r_{TOA}+r_{AOA}+r_{TDOA})+y_{TDOA}*r_{TDOA}/(r_{TOA}+r_{AOA}+r_{TDOA})

z=z_{TOA}*r_{TOA}/(r_{TOA}+r_{AOA}+r_{TDOA})+z_{AOA}*r_{AOA}/(r_{TOA}+r_{AOA}+r_{TDOA})+z_{TDOA}*r_{TDOA}/(r_{TOA}+r_{AOA}+r_{TDOA})

According to the method shown in FIG. 13, no previously obtained positioning value to refer to exists at the first step at which a calculation process starts, and therefore a prescribed initial value is given in advance at the first step. The initial value may be, for example, a mixing ratio (1:1:1) of the TOA positioning value, the AOA positioning value, and the TDOA positioning value. It should be noted that, as described with reference to FIG. 11, the most proper positioning method may be selected out of the three positioning methods, and positioning results given by the selected positioning method may be determined to be the position of the terminal 30.

Another example of a more specific method of positioning of the terminal 30 that is carried out in accordance with the method of positioning shown in FIG. 12 will hereinafter be described. A positioning method to be described below is a method of determining a weight of each of different positioning methods, based on a pre-registered preliminary error distribution in a positioning area. By referring to the preliminary error distribution in the positioning area, the ratio of a positioning value with a smaller error is increased according to the position of the terminal 30, which allows highly precise positioning.

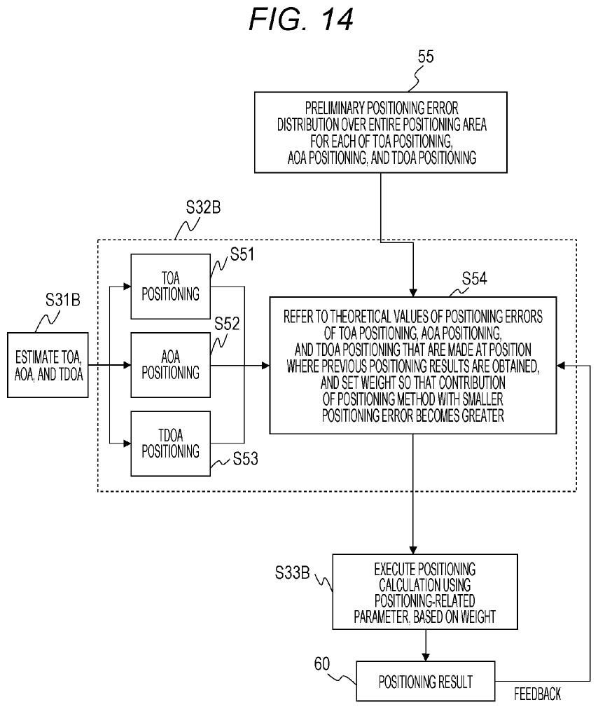

FIG. 14 depicts an example of a more specific method of positioning of the terminal 30 that is carried out in accordance with the method of positioning shown in FIG. 12. Preliminary measurement error distributions 55 over the entire positioning area, the preliminary measurement error distributions 55 corresponding respectively to different positioning methods, are stored in advance in the positioning system information database 103. The preliminary measurement error distribution indicates a relationship between coordinates and measurement errors in the positioning area. In this example, the preliminary measurement error distributions for the TOA positioning method, the AOA positioning method, and the TDOA positioning method are registered. The preliminary measurement error distributions vary depending on positioning method types, and therefore a different preliminary measurement error distribution is prepared for each positioning method.

For example, if the coordinates of base stations and the shape of the positioning area are known in advance, a theoretical value for the preliminary positioning error distribution over the entire positioning area can be calculated by a statistical simulation. Alternatively, taking actual measurements at various positions allows determination of the preliminary measurement error distribution.

As indicated in FIG. 14, the position calculation unit 101 first acquires the value of the angle of arrival (AOA), of the time of arrival (TOA), and of the time difference of arrival (TDOA), as the values of positioning-related parameters (S31B). This step S31A is the same as step S31A in FIG. 13.

The position calculation unit 101 then determines a weight of the angle of arrival (AOA), the time of arrival (TOA), and the time difference of arrival (TDOA) (S32A). To determine the weight, the position calculation unit 101 calculates the positioning value of the terminal 30, from the acquired value of each of positioning-related parameters. Calculation of the positioning value is the same calculation as described with reference to FIG. 11, and a geometric method or a statistical method can be adopted for the calculation.

In the present example, the position calculation unit 101 carries out TOA positioning (S51), AOA positioning (S52), and TDOA positioning (S53), and determines a TOA positioning value, an AOA positioning value, and a TDOA positioning value.

Further, the position calculation unit 101 determines a weight of each of the TOA positioning method, the AOA positioning method, and the TDOA positioning method, based on previously obtained positioning results and on the preliminary measurement error distribution 55 for each of these positioning methods (S54). In this example, the weight indicates a mixing ratio of each of the positioning values given by the three positioning methods in determining the current position of the terminal 30.

Specifically, the position calculation unit 101 refers to the preliminary measurement error distribution 55 for each of the TOA positioning method, the AOA positioning method, and the TDOA positioning method, and determines a positioning error made by each of these positioning methods at a position where the previous positioning result 60 is obtained. The position calculation unit 101 determines the weight of each of the three positioning methods, based on the positioning error made by each of the positioning methods. The weight is determined such that a larger weight is applied to a positioning method with a smaller positioning error value. For example, in the mixing ratio calculation method described with reference to FIG. 13, the distance d may be replaced with an error.

Based on the weight (mixing ratio) determined at step S54, the position calculation unit 101 executes a positioning calculation using three types of positioning-related parameters (S33B). As described above, the previous positioning result 60 is fed back to the process of determining the weight of the positioning method (S32B). One or more previous positioning values may be fed back.

According to the method shown in FIG. 14, no previously obtained positioning values to refer to exists at the first step at which a calculation process starts, and therefore a prescribed initial value is given in advance at the first step. The initial value may be, for example, a mixing ratio (1:1:1) of the TOA positioning value, the AOA positioning value, and the TDOA positioning value. It should be noted that, as described with reference to FIG. 11, the most proper positioning method may be selected out of the three positioning methods, and positioning results given by the selected positioning method may be determined to be the position of the terminal 30.

As described above with reference to a plurality of the configuration examples, by adaptively varying the mixing ratio of positioning values, which are given by a plurality of positioning methods, in accordance with a situation in which the positioning target is placed, highly precise positioning can be carried out.

The above positioning methods can be applied to, for example, system integration (SI) business and service business utilizing 5G evolution and 6G. For example, the positioning methods can be applied to automatic operation of industrial robots and automatic guided vehicles (AGV) in factories, automatic control of watching robots serving children, elderly persons, or the like in houses, flow line management and push-type services provided for people in commercial facilities and public facilities, and evacuation route guidance in buildings in disaster-caused emergency situations.

It should be noted that the present invention is not limited to the above-described embodiments but includes various modifications. For example, the above-described embodiments have been described in detail for easy understanding of the present invention, and are not necessarily limited to embodiments having all the described constituent elements. Some of constituent elements of a certain embodiment can be replaced with constituent elements of another embodiment, and a constituent element of another embodiment can be added to a constituent element of a certain embodiment. In addition, some of constituent elements of each embodiment can be deleted therefrom or add to or replaced with constituent elements of another embodiment.

Some or all of the above-described constituent elements, functions, processing units, and the like may be provided in the form of hardware, such as properly designed integrated circuits. In addition, the above-described constituent elements, functions, and the like may be provided in the form of software-based programs by causing a processor to interpret and execute programs for implementing the constituent elements/functions. Information for implementing functions, such as programs, tables, and files, may be stored in a storage device, such as a memory, a hard disk, and a solid state drive (SSD), or in a recording medium, such as an IC card and an SD card.

A group of control lines/data lines that are necessary for the description are illustrated, and all control lines/information lines making up the product are not necessarily illustrated. It is safe to assume that, actually, almost the entire constituent elements are interconnected.

### REFERENCE SIGNS LIST

1 positioning system
10 positioning apparatus
21, 22, 23 base station
30 terminal
31 signal transmission control unit
33 positioning-related parameter notification creating unit
35 radio signal (positioning signal)
36 reference signal
40 network
55 preliminary measurement error distribution
60 positioning result
101 position calculation unit
102 communication unit
103 positioning system information database
151 processor
153 auxiliary storage device
154 communication interface
156 interface
201 positioning-related parameter measuring unit
202 signal sender determining unit
203 positioning-related parameter notification creating unit
204 communication unit
205 memory
206, 303 antenna
213 auxiliary storage device
301 signal transmission control unit
302 signal creating unit
351, 352 positioning signal

1. A method of determining a position of a target node in accordance with radio signals transmitted and received between the target node and one or more reference nodes, the method comprising:
acquiring values of different positioning-related parameters, the values being estimated from the radio signal;
determining an error of a positioning value of the target node, the positioning value being calculated based on a value of each of different positioning-related parameters, based on at least either the positioning value or a previously determined position of the target node;
determining a weight of each of the different positioning-related parameters, based on the error; and
determining the position of the target node in accordance with a positioning value calculated based on the weight and on the value of each of the different positioning-related parameters.

2. The method according to claim 1, wherein
the weight is determined based on a likelihood of the positioning value, the likelihood being calculated from the error.

3. The method according to claim 1, wherein
the error is determined in accordance with a theoretical value based on a previously determined position of the target node and with the positioning value.

4. The method according to claim 1,
wherein for each of the different positioning-related parameters, a preliminary measurement error distribution in a positioning area of the target node is registered, and
wherein the error is determined based on the previously determined position of the target node and on the preliminary measurement error distribution.

5. The method according to claim 1, comprising:
selecting one positioning-related parameter from the different positioning-related parameters, based on the error;
giving a weight of 0 to positioning-related parameters other than the selected positioning-related parameter; and
determining a positioning value calculated based on the selected positioning-related parameter to be a position of the target node.

6. The method according to claim 1, wherein
the weight represents a mixing ratio of a positioning value calculated from each of the different positioning-related parameters, the mixing ratio being larger than 0.

7. The method according to claim 1, wherein
the different positioning-related parameters include at least two of an angle of arrival, a time of arrival, a time difference of arrival, and a signal strength.

8. An apparatus that determines a position of the target node in accordance with radio signals transmitted and received between the target node and one or more reference nodes, the apparatus comprising:
an arithmetic processing device; and
a storage device,
wherein the storage device stores coordinate information of the one or more reference nodes, and
wherein the arithmetic processing device carries out the processes of:
acquiring values of different positioning-related parameters, the values being estimated from the radio signal;
calculating a positioning value of the target node, based on a value of each of different positioning-related parameters and on the coordinate information of the one or more reference nodes;
determining an error of the positioning value, based on at least either the positioning value or a previously determined position of the target node;
determining a weight of each of the different positioning-related parameters, based on the error; and
determining the position of the target node in accordance with a positioning value calculated based on the weight and on the value of each of the different positioning-related parameters.
